(19) United States
(12) Patent Application Publication
(10) Pub. No.: US 2007/0119282 A1
(43) Pub. Date: May 31, 2007

(54) Handle grip for domestic tools

(76) Inventor: Elizabeth Ka Ying Lee, Discovery Bay (HK)

Correspondence Address: POLSINELLI SHALTON FLANIGAN SUELTHAUS PC, 700 W. 47TH STREET, SUITE 1000, KANSAS CITY, MO, 64112-1802, US

(21) Appl. No.: 11/287,904

(22) Filed: Nov. 28, 2005

Related U.S. Application Data
(60) Provisional application No. 60/735,322, filed on Nov. 10, 2005.

(51) Int. Cl. B25G 1/01

(52) U.S. Cl. 81/489

(57) ABSTRACT

A handle grip useful for securing to domestic tools such as utensils and cleaning apparatus, comprising a spine, and at least one wing extending from the spine, said wing being deformable. In preferred embodiments the handle grip comprises more than one deformable wing, with said wing or wings preferably being capable of moving in a substantially arcuate path toward the spine.

The present invention describes improved handle grips for domestic tools such as kitchen utensils and household cleaning equipment. Specifically, the invention provides for handle grips that are comfortable to use over long periods of time and are able to fit different sized hands. It is envisaged that the invention may be of particular use for people with compromised dexterity in their hands.

### BACKGROUND

Domestic tools (such as kitchen utensils or household cleaning equipment) come in all shapes and sizes, and have several different uses. One problem encountered with common domestic tools is that manufacturers do not appreciate that users of domestic tools have hands of different shapes and sizes. Furthermore, non-ergonomic handles may lead to the tools being uncomfortable to use over long periods of time.

Another problem with domestic tools is that users with limited dexterity may encounter problems obtaining a proper grip on ordinary handles. For example, arthritis sufferers can find using everyday kitchen utensils particularly difficult.

One proposed solution has been to cover the too handle with a sculpted block of sponge-like material so that the sponge-like material temporarily deforms to fit the user's hand when in use. While useful, such handles are not easy to clean, and are susceptible to damage with repeated use.

It is therefore an object of the present invention to provide an improved or alternative handle for a domestic tool.

### SUMMARY OF INVENTION

In a first aspect, the invention broadly describes a handle grip comprising a spine portion, and at least one wing extending from the spine, said wing being deformable.

In a preferred embodiment, at least part of the wing's outer edge is capable of moving closer to the spine. In an alternative embodiment, the wing's outer edge is capable of moving away from the spine.

In a particularly preferred embodiment the handle grip has two wings.

Preferably the wing's outer edge is capable of moving in a substantially arcuate path toward the spine.

The spine may be permanently attached to the handle of the domestic tool, or alternatively may itself be the handle of the domestic tool. In an alternative embodiment, the spine is releasably engageable with the handle of a domestic tool.

Preferably the wing or wings radially extend from the spine. Alternatively, the wing or wings tangentially extend from the periphery of the spine.

In one embodiment the spine comprises a cavity capable of securely housing a utensil handle. While in this embodiment it is preferred that the cavity of the attachment portion is substantially circular, it is foreseeable that other cavity shapes might be appropriate for accommodating different shaped utensil handles, such as cutlery handles. The spine may comprise an amount of elastic material, so as to more easily accommodate handles of different sizes. The elastic material may be in the form of thin elastic material, or webbed elastic material.

Preferably the wing or wings form a substantially rectangular shape when viewed from the front. In an alternative embodiment, the wing or wings could form a substantially circular shape.

In a preferred embodiment, one or both of the surfaces of the wing or wings possess an increased surface friction. This increased friction may be achieved by incorporating patterned ridges on the surface of the wing or wings. Such ridges may also provide the wing with increased flexibility.

The handle grip is preferably made from either thermoset materials (such as silicone) or thermoplastic materials (such as thermoplastic rubber (TPR), thermoplastic elastomers (TPE), synthetic rubbers, polyvinylchloride), or combinations thereof.

A preferred method of manufacturing the handle grip is injection molding, although other suitable methods would be apparent to a skilled reader (for example, compression molding, slush molding, or rotocasting).

The invention may broadly be said to consist in any alternative combination of features as described or shown in the accompanying drawings. Known equivalents of these features not expressly set out are nevertheless deemed to be included.

### BRIEF DESCRIPTION OF THE FIGURES

FIG. 1 is a front view according to one embodiment of the invention.

FIG. 2 is a back view according to one embodiment of the invention. This shows the side of the handle grip which is in contact with a user's hand.

FIG. 3 is a side view according to one embodiment of the invention. FIG. 3a shows a side view of an alternate embodiment of the invention.

FIGS. 4a, 4b and 4c show perspective views from the lower end of a handle grip according to different embodiments of the invention.

FIGS. 5a and 5b show a perspective views and a front view of an embodiment of the invention when in use.

FIG. 6 is a schematic drawing of a hand holding the handle grip.

FIG. 7a and 7b are schematic drawings showing how one embodiment of the invention engages with a domestic tool (in this Figure, a spoon).

FIG. 8 is shows an embodiment of the invention in use where the wings move away from the spine.

### DETAILED DESCRIPTION OF THE INVENTION

Throughout the specification, any reference to a “domestic tool” means a tool or utensil commonly used in a household. Without limiting the scope of the term, this could encompass kitchen utensils (such as spatulas or serving implements) as well as cleaning equipment (such as scrubbing brushes and brooms).

Any references to ridges being formed “on” a wing or wings can mean that the ridges could be formed on top of the wing surface, or alternatively that the wing surface itself is moulded to create the ridges.

As the handle grip may be formed as a unitary body, it should be appreciated that where the specification refers to more than one wing, they may not in fact be physically separate wings, as they may be part of the same unitary body.

It will also be appreciated that any reference to “a wing” may also intend to refer to a second wing on the particular embodiment of the handle grip being described.

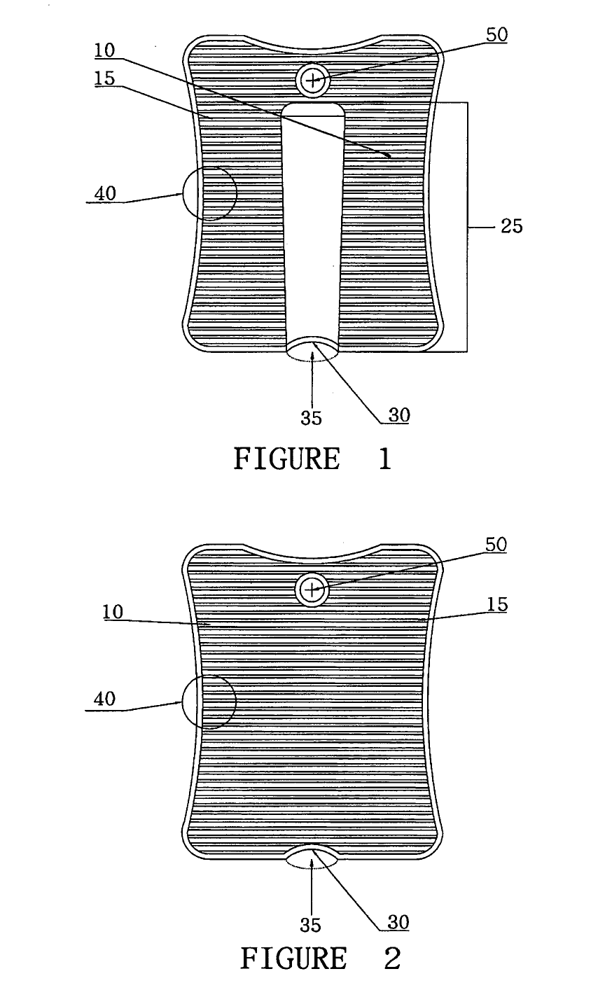

FIG. 1 shows a front view according to one embodiment of the invention. In this particular embodiment there are two wings (10, 15) which extend from the spine (25). The wings (10, 15) have outer edges which move closer to the spine when in use.

In this embodiment the spine is shaped so that it is capable of releasably engaging a utensil handle. A cavity (30) is formed in the spine to as to securely accommodate a utensil handle. The utensil handle is inserted into the cavity (30) via the cavity entrance (35). The cavity is preferably substantially circular, although other shaped cavities would be appropriate for different shaped utensil handles (for example cutlery).

This embodiment also shows an aperture (50) in the handle grip which can be used for hanging the handle grip on a hook for convenient storage (whether attached to a utensil or not).

In one embodiment, the wing or wings may be detachable from the spine. This would make it possible for one set of wings to be used with different sized spines capable of fitting onto different sized handles. Alternatively, different sized or different shaped wings could be used with one spine, so that users with different hand sizes could attach the appropriate sized/shaped wings onto the spine.

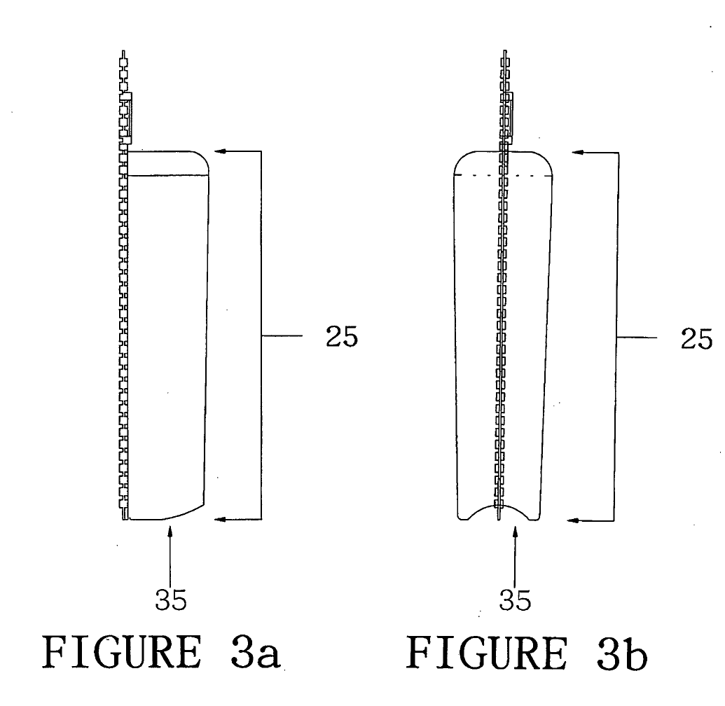

FIG. 2 shows a back view of the embodiment of the invention depicted in FIG. 1. In this embodiment, the surfaces of the wings (10,15) have ribs formed thereto, providing more friction, and thus a better grip for the user. The ribs can be formed over the entire surface of the wing or wings, or alternatively in predetermined areas. The ribs can be formed in any shape or pattern as desired.

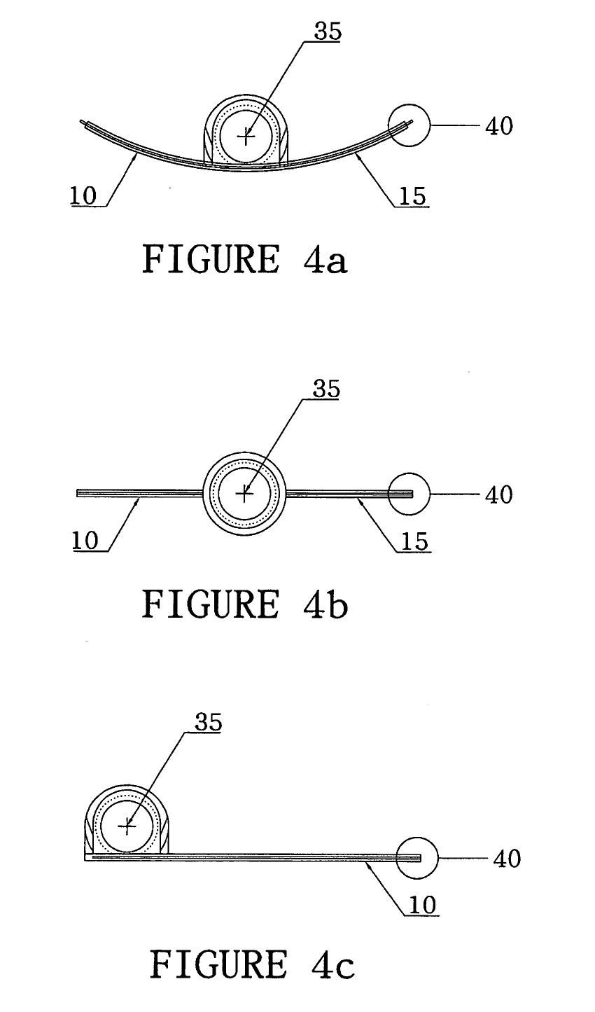

FIG. 3a shows a side view of one embodiment of the invention. In this particular embodiment, the wings extend tangentially from the circumference of the spine. In FIG. 3b the wings radially extend from the spine.

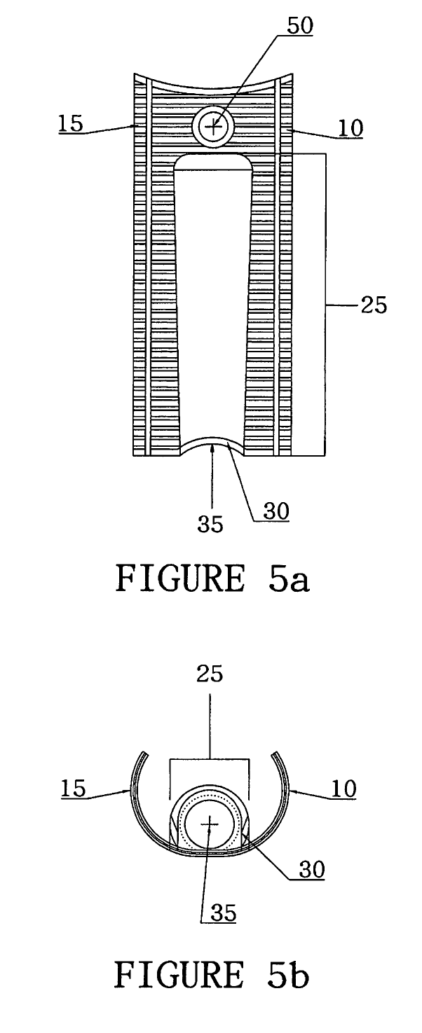

FIGS. 4a, 4b and 4c are longitudinal views of the lower end of the handle grip, where the cavity entrance (35) is located. In the embodiment shown in FIG. 4a, the wings (10,15) are slightly curved when the handle grip is not in use. This configuration is especially beneficial to users with limited dexterity, as less effort is required to deform the wings from their resting position. In embodiment 4b the wings extended radially from the cavity, while the embodiment in 4c shows a handle grip with a single wing extending tangentially from the circumference of the cavity. As noted above, it is possible that other cavity shapes may be appropriate for attaching to different shaped utensil handles.

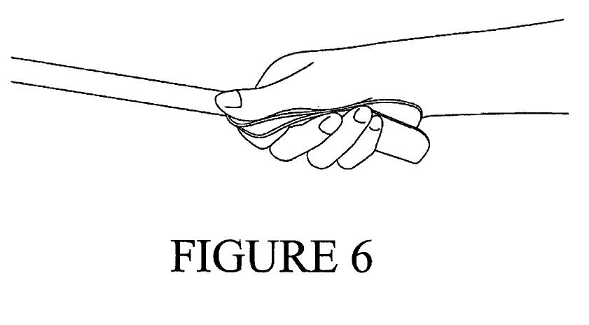

FIGS. 5a and 5b show the shape of an embodiment of the invention when in use. The deformability of the wings (10,15) allows the handle grip to adapt to accommodate hands of varying sizes. Advantageously, the configuration with two wings means that one wing can deform more than the other if necessary-depending on the user's hand shape and strength.

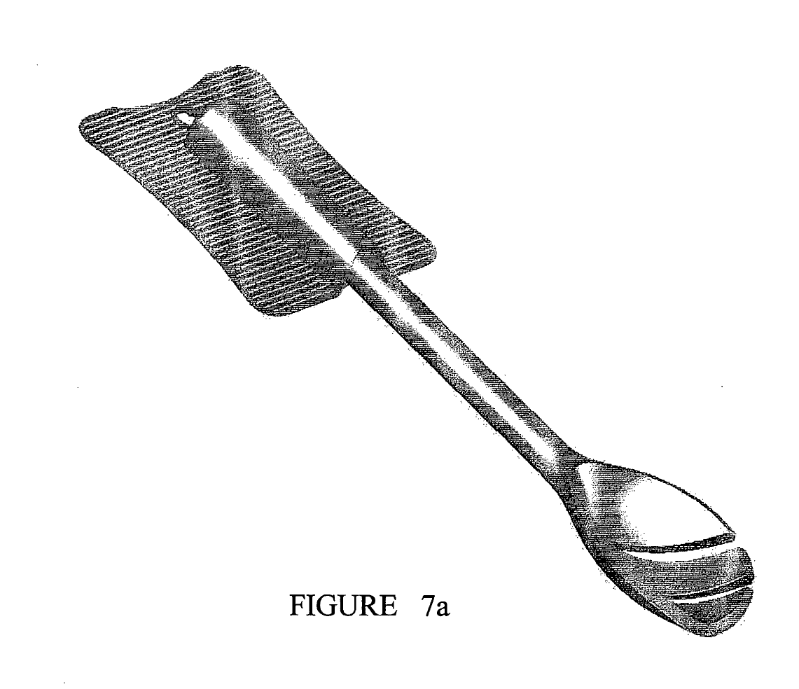

FIG. 6 shows a user's hand gripping the handle grip. It is also envisaged that the handle grip could be adapted for handles in a horizontal alignment (for example on certain types of corkscrews).

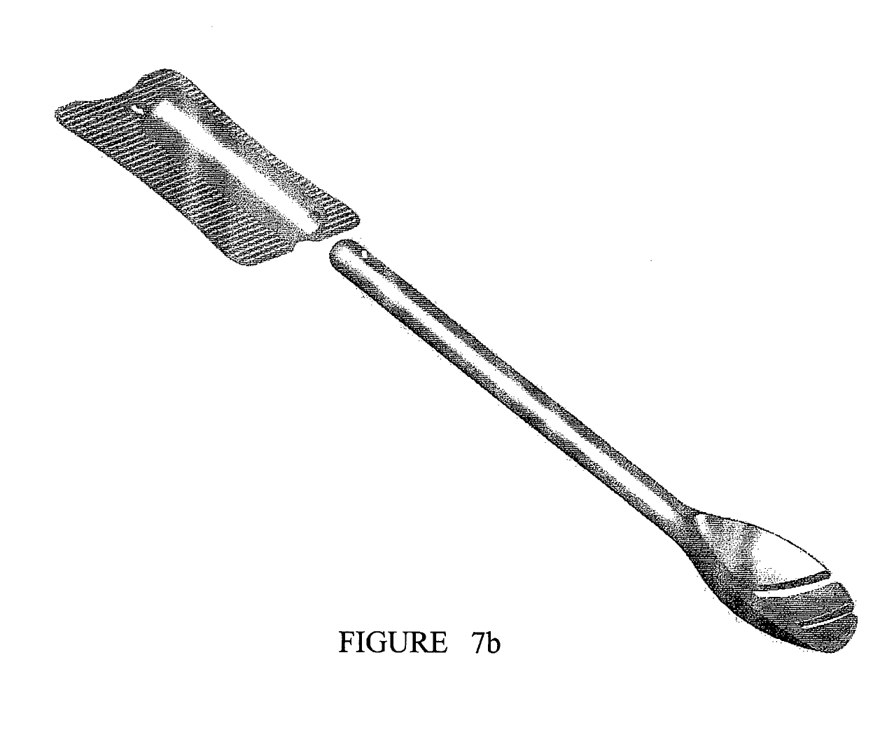

FIGS. 7a and 7b are schematic illustrations of how an embodiment of the invention is attached with a domestic utensil, such as a spoon. Alternatively, the handle can be formed integrally in the domestic tool.

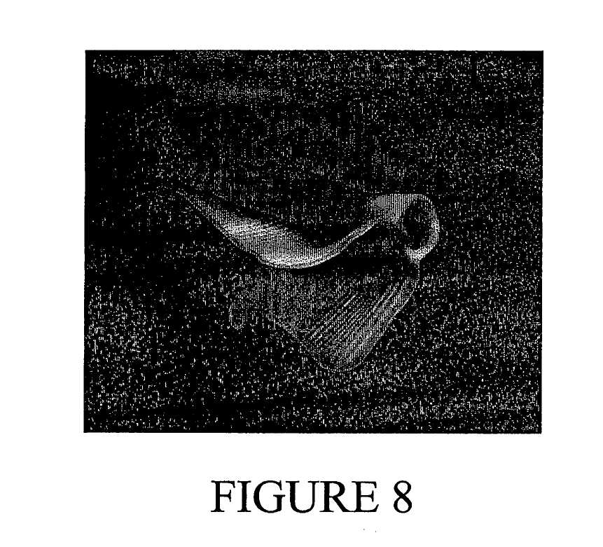

FIG. 8 shows an embodiment of the invention in use where the wings move away from the spine.

The invention is of particular use for making the handles of domestic tools more comfortable to use, especially over long periods of time. It is envisaged that the invention will also be of use for users of domestic tools who have compromised dexterity, for example arthritis sufferers. A handle according to the invention is capable of fitting a range of hand sizes and shapes, meaning that many users of a household could use a single grip.

The above describes some preferred embodiments of the present invention and indicates several possible modifications, but it will be appreciated by those skilled in the art that other modifications can be made without departing from the scope of the invention.

What we claim is:

1. A handle grip comprising a spine, and at least one wing extending from the spine, said wing being deformable.

2. A handle grip according to claim 1 wherein the handle grip has two wings extending from the spine.

3. A handle grip according to claim 1 wherein at least part of the wing's outer edge is capable of moving closer to the spine.

4. A handle grip according to any one of claims 1 or 2 wherein the outer edge of the wing is capable of moving in a substantially arcuate path toward the spine.

5. A handle grip according to any one of claims 1 or 2 wherein the spine is permanently attached to the handle of a domestic tool.

6. A handle grip according to anyone of claims 1 or 2 wherein the spine is the handle of the domestic tool.

7. A handle grip according to anyone of claims 1 or 2 wherein the spine is releasably engageable with the handle of a domestic tool.

8. A handle grip according to claim 7 wherein the spine comprises a cavity for securely housing the handle of a domestic tool.

9. A handle grip according to claim 7 wherein the spine comprises an amount of elastic material.

10. A handle grip according to claim 2 wherein the wings form a substantially rectangular shape when viewed from the front.

11. A handle grip according to claim 2 wherein the wings form a substantially circular shape when viewed from the front.

12. A handle grip according to either of claims 1 or 2 wherein one or both surfaces of the wing or wings possess increased surface friction.

13. A handle grip according to either of claims 1 or 2 wherein ridges are formed on the surface of the wing or wings.

14. A handle grip according to claim 13 wherein the ridges are patterned.

15. A handle grip according to either of claims 1 or 2 made from: thermoplastic rubber (TPR), thermoplastic elastomers (TPE), synthetic rubbers, polyvinylchloride, thermoset materials, or combinations thereof.

16. A handle grip according to claim 15 comprising an amount of thermoset material, wherein the thermoset material is silicone.

16. A handle grip according to either one of claims 1 or 2 wherein the wing or wings extend tangentially from the circumference of the spine.

17. A handle grip according either one of claims 1 or 2 wherein the wing or wings extend radially from the spine.

18. A handle grip according to either one of claims 1 or 2 wherein the wing or wings are detachable from the spine.

19. A handle grip according to either one of claims 1 or 2 wherein at least part of the wing's outer edge is capable of moving away from the spine.
